(19) United States
(12) Patent Application Publication
(10) Pub. No.: US 2023/0288096 A1
(43) Pub. Date: Sep. 14, 2023

(54) Air Conditioner Unit Drain Line Chlorinator

(71) Applicant: Jacob Trent Hearnsberger, Springhill, LA (US)

(72) Inventor: Jacob Trent Hearnsberger, Springhill, LA (US)

(21) Appl. No.: 17/692,328

(22) Filed: Mar. 11, 2022

(51) Int. Cl. F24F 13/22; C02F 1/68

(52) U.S. Cl. CPC F24F 13/222; C02F 1/688; F24F 2013/228; C02F 2303/22

(57) ABSTRACT

The present disclosure provides a chlorinator apparatus for installation in the drain line of an air conditioning unit such as a household HVAC unit. The chlorinator apparatus is configured to hold a stack of tablets in a chamber such that they are partially submerged in a flow of water running through the drain line, thereby steadily dissolving in the flow and providing a long term blockage solution of the drain line, removing the need for regular application of bleach and other chemicals and preventing water build up and damage to the AC unit.

### FIELD OF INVENTION

The present invention relates generally to a drain line chlorinator for an AC unit. More specifically, the present invention relates to a T-junction pipe assembly that can be installed along the drainpipe of an AC unit to steadily dissolve chlorine tablets therein.

### BACKGROUND

In new homes, regulations now usually require air conditioner condensate lines to be integrated into the home's plumbing system or to have drain lines run from them.

A problem associated with this is that the condensate water is not pure and can lead to build ups in the connected drain line/plumbing pipe, which can thus become blocked quickly if it is not maintained by regularly addition of chemicals such as bleach or vinegar to the condensate, or by cleaning it out manually.

Such blockages lead to musty, moldy smells near the AC unit and in the air cycled through vents in the home by the AC unit. It can also lead to standing water and thus water damage to the unit, causing it to stop operating in the worst cases.

It is within this context that the present invention is provided.

### SUMMARY

The present disclosure provides a chlorinator apparatus for installation in the drain line of an air conditioning unit such as a household HVAC unit. The chlorinator apparatus is configured to hold a stack of tablets in a chamber such that they are partially submerged in a flow of water running through the drain line, thereby steadily dissolving in the flow and providing a long term blockage solution of the drain line, removing the need for regular application of bleach and other chemicals and preventing water build up and damage to the AC unit.

Thus, according to one aspect of the present disclosure there is provided an apparatus for chlorinating a flow of water from an AC unit drain pipe, the apparatus comprising: a T-junction pipe, the T-junction pipe comprising a first length of pipe having opposing ends each configured to couple and form a watertight seal with respective portions of a drainpipe, and an open-ended second length of pipe extending orthogonally from a central portion of the first length; and a tablet chamber, the tablet chamber comprising a third length of pipe having a first open end sealed with a removable cap and an opposing second closed end configured to hold a stack of tablets inside and proportioned so as to be inserted into the opening of the second length of pipe so that the closed end rests within the first length of pipe of the T-junction, the first closed end having formed therein one or more openings for allowing water to flow through.

In some embodiments, an inside surface of the first open end of the tablet chamber is threaded and there is a corresponding outward facing threaded portion on the removable cap.

In some embodiments, the second end of the tablet chamber is proportioned so that the one or more openings, and any tablet resting at the bottom of the stack and adjacent to the second end, will rest at the average height of a flow of water from the drainpipes running through the T-junction pipe, steadily dissolving the bottom tablet.

In some embodiments, the one or more openings are formed in the end wall of the tablet chamber.

In some embodiments, the one or more openings are formed in the curved walls of the second end of the tablet chamber.

In some embodiments, the removable cap comprises a hollow indent for increasing the number of tablet which can be stacked within the tablet chamber.

In some embodiments, the T-junction pipe and/or the tablet chamber is formed of poly-vinyl-chloride, PVC.

### BRIEF DESCRIPTION OF THE DRAWINGS

Various embodiments of the invention are disclosed in the following detailed description and accompanying drawings.

FIG. 1 illustrates an exploded components view of an example configuration of drain pipe chlorinator apparatus according to the present disclosure.

FIG. 2 illustrates an isometric perspective view of the example configuration of the chlorinator apparatus in an assembled state.

FIG. 3 illustrates an isometric view of a set of chlorine tablets being inserted into the tablet chamber of the example configuration of the chlorinator apparatus.

FIG. 4 illustrates a side view of the example chlorinator apparatus installed along a drainpipe leading from an AC unit.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

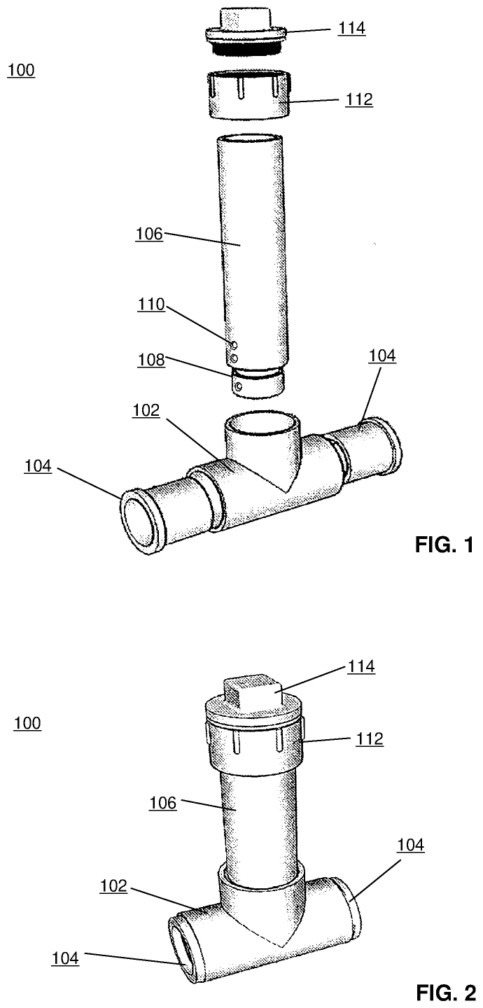

Referring to FIG. 1, an exploded components view of an example configuration of a drain pipe chlorinator apparatus 100 according to the present disclosure is shown.

As can be seen, the apparatus 100 is comprised of a T-junction pipe 102 with opposing ends 104 each configured to couple to corresponding ends of a drain line that runs from an AC unit such as a HVAC. In the present example the ends 104 are actually separate pieces that slot into the T-junction pipe 102 and adapted so as to form a tight seal with the ends of the drain line. This way the water flowing through the drain line will flow through the length of the T-junction unimpeded and at a constant height if the line and apparatus are oriented flat across the horizontal plane.

A third opening extends orthogonally from the centre portion of the T-junction pipe 102, and the apparatus comprises a tablet chamber 106 configured to slot into that opening. The end of the tablet chamber 106 that is inserted into the T-junction 102 is closed, in the present example this is done with a cap 108. The cap 108, and the walls at the end of the tablet chamber 106, have a plurality of openings 110 formed into them. These openings can be formed both in the rounded walls of the chamber and the flat wall of the cap (not visible in the figure).

As the tablet chamber 106 is hollow, a stack of chlorine tablets (or other similar chemical tablets) can be inserted into it so that the bottom tablet of the stack sits within the T-junction pipe 102 and is at least partially submerged in a flow of water running from the drain line through the T-junction. The openings 110 allow this flow to come into contact with the chlorine tablet which thus steadily dissolves in the flow of condensate, preventing blockages further along the drain line. The length of the T-junction pipe 102 needs to be oriented flat on the horizontal plane for this to function properly.

The opposing end of the tablet chamber 106 is provided with a removeable cap, which in the present example is formed of a first portion 112 having an inner threaded surface and a second portion 114 having a corresponding outward facing threaded surface that can be twisted together to seal the cap, or removed to insert more tablets.

The apparatus 100 can be seen in an assembled state in FIG. 2.

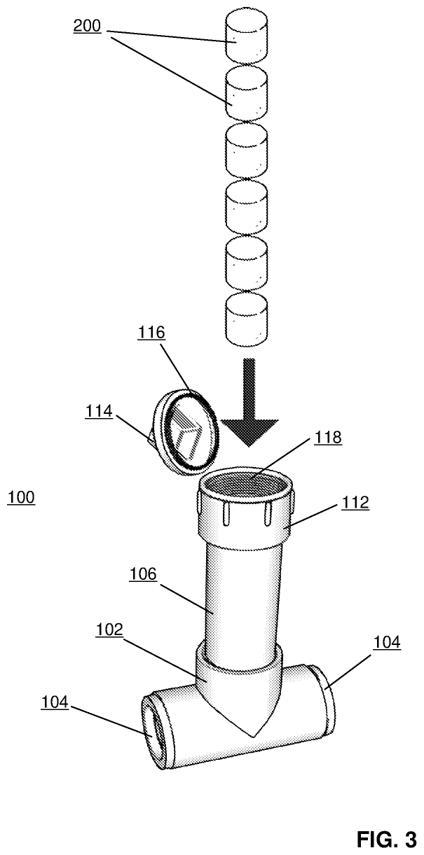

FIG. 3 illustrates the top portion 114 of the cap having been removed and a set of tablets 200 being inserted into the hollow space of the tablet chamber 106. The outward facing threaded surface 116 and the inner threaded surface 118 are visible here with the cap removed.

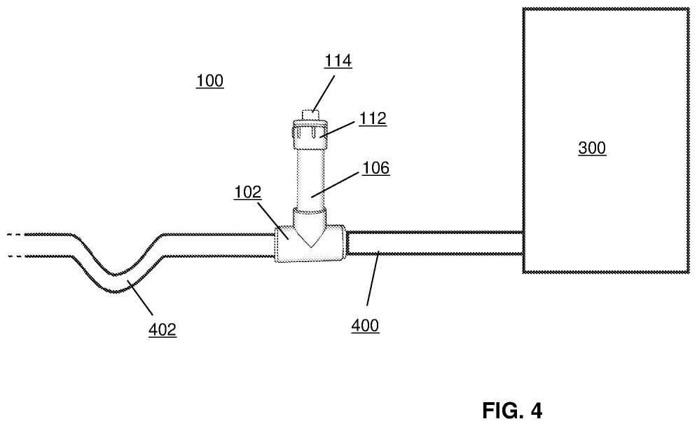

Referring to FIG. 4, the apparatus 100 is shown installed along the length of a drain line 400 which runs from a HVAC unit 300. The apparatus 100 must be installed between the HVAC unit 300 and the kink or trap 402 of the drain line, and must be oriented horizontally as shown.

The T-junction pipe and/or the tablet chamber may both be formed of poly-vinyl-chloride, PVC or another suitable plastic.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the chlorinator apparatus have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An apparatus for chlorinating a flow of water from an AC unit drain pipe, the apparatus comprising:
a T-junction pipe, the T-junction pipe comprising a first length of pipe having opposing ends each configured to couple and form a watertight seal with respective portions of a drainpipe, and an open-ended second length of pipe extending orthogonally from a central portion of the first length; and
a tablet chamber, the tablet chamber comprising a third length of pipe having a first open end sealed with a removable cap and an opposing second closed end configured to hold a stack of tablets inside and proportioned so as to be inserted into the opening of the second length of pipe so that the closed end rests within the first length of pipe of the T-junction, the first closed end having formed therein one or more openings for allowing water to flow through.

2. An apparatus for chlorinating a flow of water according to claim 1, wherein an inside surface of the first open end of the tablet chamber is threaded and there is a corresponding outward facing threaded portion on the removable cap.

3. An apparatus for chlorinating a flow of water according to claim 1, wherein the second end of the tablet chamber is proportioned so that the one or more openings, and any tablet resting at the bottom of the stack and adjacent to the second end, will rest at the average height of a flow of water from the drainpipes running through the T-junction pipe, steadily dissolving the bottom tablet.

4. An apparatus for chlorinating a flow of water according to claim 1, wherein the one or more openings are formed in the end wall of the tablet chamber.

5. An apparatus for chlorinating a flow of water according to claim 1, wherein the one or more openings are formed in the curved walls of the second end of the tablet chamber.

6. An apparatus for chlorinating a flow of water according to claim 1, wherein the removable cap comprises a hollow indent for increasing the number of tablet which can be stacked within the tablet chamber.

7. An apparatus for chlorinating a flow of water according to claim 1, wherein the T-junction pipe and/or the tablet chamber is formed of poly-vinyl-chloride, PVC.
